(19) United States
(12) Patent Application Publication
(10) Pub. No.: US 2012/0211181 A1
(43) Pub. Date: Aug. 23, 2012

(54) Vehicle Roller Shutter

(75) Inventors: Jeff Ferguson, Sparta, WI (US); Karl-Johan Lofqvist, Syrso (SE)

(73) Assignee: NORTHERN ENGRAVING CORPORATION, Sparta, WI (US)

(21) Appl. No.: 13/265,610

(22) PCT Filed: Apr. 20, 2010
(86) PCT No.: PCT/US2010/031732

§ 371 Date: Apr. 19, 2012

Related U.S. Application Data
(60) Provisional application No. 61/171,672, filed on Apr. 22, 2009.

(51) Int. Cl. B60J 3/00

(52) U.S. Cl. 160/370.22

(57) ABSTRACT

Lateral elements for use in a roller shutter useful for screening an opening, the roller shutter includes a plurality of lateral elements which together form shutter wherein the plurality of lateral elements are able to pivot with respect to one another without disengaging to allow the shutter to bend around a corner to expose the opening.

This application claims priority to U.S. provisional patent application No. 61/171,672, filed on Apr. 22, 2009, the specification of which is incorporated herein by reference.

### BACKGROUND OF THE INVENTION

(1) Field of the Invention

This invention concerns a roller door or roller shutter for screening an opening such as an opening in an automobile or truck. The shutter includes a plurality of lateral elements which together form shutter when located in a track across a covered opening. The plurality of lateral elements are able to pivot with respect to one another without disengaging to allow the shutter to bend around a corner to expose the opening.

(2) Background of the Invention

Roller doors/shutters are used in many applications to cover openings. In particular, roller shutters are useful in covering non-planar openings. Vehicles such as automobiles can typically include non-planar openings. However, roller shutters are not typically considered as suitable for covering such openings because they include may pieces that can be prone to being damaged especially in an automobile environment where components are subjected to harsh environmental conditions and unwanted vibrations. There is a need, therefore, for a roller shutters that are useful to cover planar and non-planar openings in the cabin of an automobile.

### SUMMARY OF THE INVENTION

One aspect of the invention is a lateral element useful in a roller shutter, the lateral element having a length that is greater than its width and further comprising a front face, back, a first edge and a second edge, the back including one or more strengthening ribs and a locking rib extending beyond the first edge of the lateral element.

Another aspect of this invention is a roller shutter for screening an opening, the rolled shutter including a plurality of lateral sliding elements, each sliding element having a length that is greater than its width and each lateral sliding element associated with at least one other sliding element wherein each sliding element further comprises: at least one lateral strengthening rib; and a locking rib that extends to cover a portion of an adjacent lateral sliding element.

### DESCRIPTION OF THE FIGURES

FIG. 1 is a side cut-away view of a lateral element embodiment of a roller shutter of this invention;

FIG. 2 is a perspective view of a roller shutter including lateral elements that are pivoted as they travel around a corner;

FIG. 3 is a side cut-away view of an end of the roller shutter including the end element and several lateral elements; and

FIG. 4 is front view of a roller shutter including a plurality of lateral elements;

### DESCRIPTION OF EXEMPLARY EMBODIMENTS

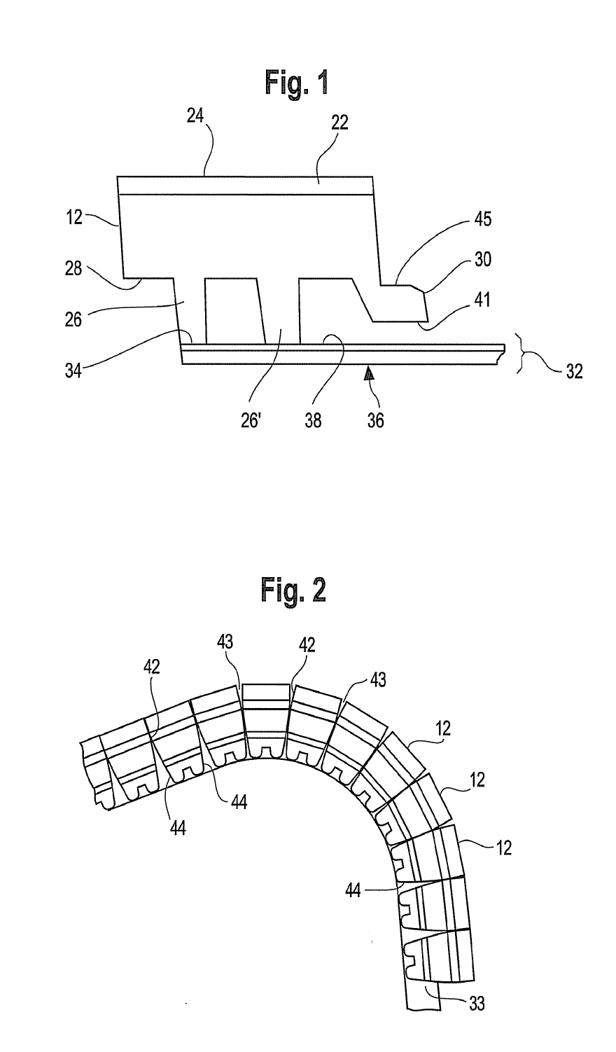

The present invention relates to a roller shutter 10 for use in for screening any opening but preferably for screening an opening in an automobile or truck. Embodiments of a roller shutter of this invention and or elements of roller shutters of this invention are shown in FIGS. 1-4. Referring to FIG. 1, there is shown a cross-section view of a single lateral element 12 used in roller shutter 10. Lateral element 12 will have a length that is greater than its width and preferably a length that is five or more times its width. Lateral element 12 further includes a face 22, a back 28, a first edge 23 and a second edge 25. The lateral element back 28 may include one or more strengthening ribs 26 and may include a locking rib 30 that extending beyond an edge 23 or 25 of lateral element 12.

Face 22 will be visible to the observer when roller shutter 10 covers an opening. Face 22 may be decorated such as by painting or printing, it may be undecorated, or it may include a decorative layer 24 such as a metal sheet, wood veneer, or decorated plastic film. In one embodiment, decorative layer 24 is an aluminum sheet material having a thickness of from 0.25 mm to about 1 mm thick and preferably about 0.5 mm thick that is undecorated or decorated.

Each lateral element 12 optionally includes one or more strengthening ribs 26 associated with back surface 28. Strengthening ribs 26 may run along part or the entire lateral back surface 28 of lateral element 12. Strengthening ribs 26 will have a depth X of from about 0.75 mm to about 3 mm and a width Y of from about 0.75 mm to about 2.0 mm. In the embodiment shown in FIG. 1, lateral element 12 includes two strengthening ribs 26 and 26′.

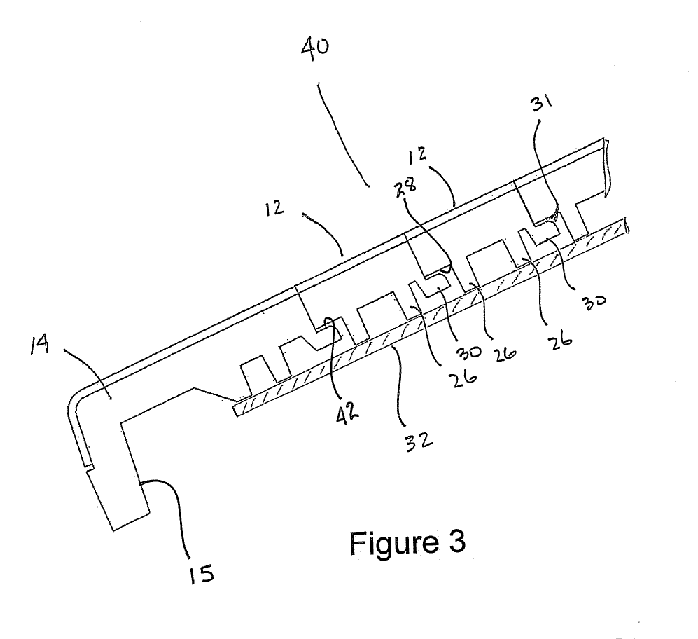

Each lateral element 12 also includes a locking rib 30. Locking rib 30 extends from first or second end 23 or 25 of lateral element 12 towards an adjacent lateral element such that locking rib 30 covers, preferably without touching, a portion of a recess 29 formed in back surface 28 of adjacent lateral element 12. In FIG. 1, locking rib includes a first surface 41 and a second surface 45. When two lateral elements 12 are placed adjacent to one another as shown in FIG. 3, there is preferable a small gap 31 between second surface 45 of locking rib 38 and the back 20 of lateral element 12.

One purpose of locking rib 30 is to prevent lateral element deflection when force is applied to the face of the assembled shutter. Locking rib 30 may have a lateral length that is shorter than or that is equal to the lateral length of lateral element 12. Alternatively, lateral element 12 can include a plurality of spaced locking ribs located along a portion of or the entire length of lateral element 12. Gap 31, when present, will have a width of from about 0.1 mm to about 0.5 mm and preferably about 0.25 mm.

A backing sheet 32 is optionally applied to the rear of the assembled roller shutter 10 as shown in FIGS. 2-4. Backing sheet 32 is applied to the surface 34 of strengthening ribs 26. Backing sheet 32 will typically include a flexible sheet material 36 and an adhesive layer 38 with the adhesive layer providing the bond between the backing sheet and the roller shutter strengthening ribs. The flexible sheet material 36 can be any flexible sheet material that is resilient and that is resistant to failure due to bending or creasing. Example so useful flexible sheet materials include, but are not limited to, fabrics, woven glass cloth, and polymer films. The adhesive layer 38 may be any adhesive that is capable of essentially irreversibly securing the flexible sheet material 36 to the strengthening ribs 26. A preferred adhesive material is a heat activated adhesive such as a hot melt urethane based adhesive. One purpose of backing sheet 32 is to hold the individual lateral elements together especially when roller shutter 10 is opened and closed so strengthening ribs 26 do not bind. In addition, by holding lateral elements 12 together, the pivot gap 43 (shown in FIG. 2) formed between adjacent lateral element faces 22 when the roller shutter bends around a corner is minimized and the opening behind the roller shutter is hidden from observation by the backing sheet 32 as well.

FIG. 3 shows an end section 40 of a roller shutter 10 embodiment of this invention including several lateral elements 12 and end piece 14. End piece 14 includes a stop 15 that acts in conjunction with barriers in the opening covered by roller shutter to prevent roller shutter from being opened or closed too far.

FIG. 2 shows a section of roller shutter 10 as it would appear turning a corner formed by groove 33 as it is opened or closed. The roller shutter 10 includes a plurality of adjacent lateral elements 12. Moreover, the rear portion of side walls 42 of lateral elements 12 include an inward taper 44. The combination of inward taper 44 and backing sheet 32 inhibit separation of the lateral elements 12 during the opening a closing process thereby hiding the opening from view. In addition the gap 43 formed by pivoting lateral elements should be no greater than about 2 mm and ideally about 1.4 mm or less.

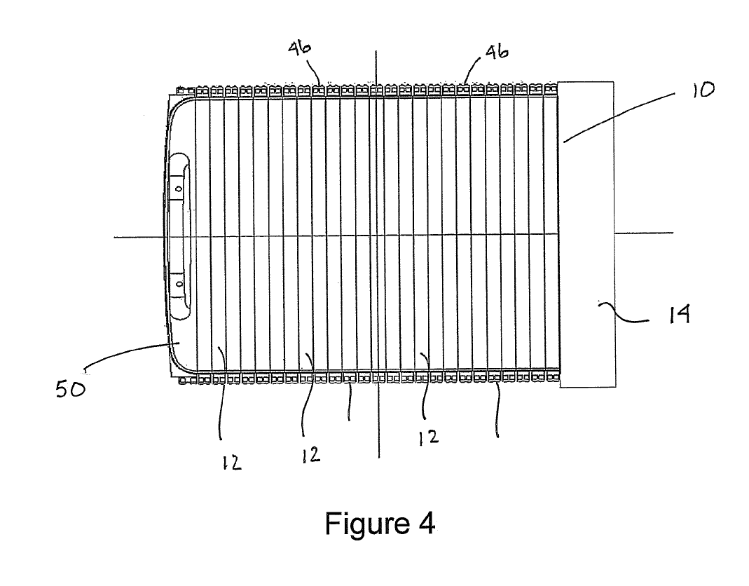

FIG. 4 is a front view of a roller shutter 10 embodiment of this invention. The roller shutter includes end piece 14 at one end, a handle 50 at the other end, a plurality of lateral elements 12 located between end piece 14 and handle 50. Lateral elements 12 includes feet 46 and 50 that are placed in a top grove and bottom groove 33 respectfully such that feet 46 are not visible to the viewer. The top and bottom grooves retain feet 46 and 50 and in turn secure the roller shutter 10 in place between the opposing grooves were feet 46 and 50 slide in the groves when the user pushes or pulls on handle 50 to cause roller shutter to expose and cover an opening.

The number of sliding lateral elements 12 in the roller shutter is preferably between 5 and 25. Lateral element 12 and well as the handle 50 and end piece 14 are preferably made from a light weight plastic material and may be molded in one piece, for example by extrusion or cast molding. The plastic material may comprise glass fibers or another suitable fiber for reinforcing the plastic material. One example of a suitable material is PA6GF30, which is a commercial plastic comprising Polyamide 6 reinforced with the addition of 30% glass fiber and graphite.

What is claimed is:

1. A lateral element useful in a roller shutter, the lateral element having a length that is greater than its width and further comprising a front face, back, a first edge and a second edge, the back including one or more strengthening ribs and a locking rib that extends beyond the first edge of the lateral element.

2. The lateral element of claim 1 wherein the locking rib extends along essentially the entire length of the first edge of the lateral element.

3. The lateral element of claim 1 wherein each strengthening rib extends along essentially the entire length of the lateral element.

4. The lateral element of claim 1 including two or more strengthening ribs.

5. The lateral element of claim 1 including a recess for accepting a locking rib of an adjacent lateral element

6. A roller shutter for screening an opening comprising:
a plurality of lateral sliding elements, each sliding element having a length that is greater than its width and each lateral sliding element associated with at least one other sliding element wherein each sliding element further comprises:
at least one lateral strengthening rib; and
a locking rib that extends to cover a portion of an adjacent lateral sliding element.

7. The roller shutter of claim 6 including a backing sheet that covers the back of the plurality of lateral sliding elements.

8. The roller shutter of claim 7 wherein the backing sheet is formed from a flexible sheet material and an adhesive layer wherein the adhesive layer is applied to the back of the plurality of lateral sliding elements.

9. The roller shutter of claim 7 wherein the backing sheet is adhesively attached to the strengthening ribs of each of the plurality of lateral sliding elements.

10. The roller shutter of claim 6 wherein the locking rib of each lateral element extends along essentially the entire length of the first edge of the lateral element.

11. The roller shutter of claim 6 wherein each strengthening rib extends along essentially the entire length of the lateral element.

12. The roller shutter of claim 6 wherein each lateral element includes two or more strengthening ribs.

13. The roller shutter of claim 6 wherein each lateral element includes a recess for accepting a locking rib of an adjacent lateral element.
